(19) United States
(12) Patent Application Publication
(10) Pub. No.: US 2025/0319780 A1
(43) Pub. Date: Oct. 16, 2025

(54) ELECTRIFIED VEHICLE CHARGING ASSEMBLY HAVING A SWIVEL JOINT

(71) Applicant: Ford Global Technologies, LLC, Dearborn, MI (US)

(72) Inventors: Kevin Mackenzie, Canton, MI (US); Jonathan Barker, Detroit, MI (US); Kevin Higgins, Waterford, MI (US)

(21) Appl. No.: 18/634,716

(22) Filed: Apr. 12, 2024

(51) Int. Cl. B60L 53/16; B60L 53/18

(52) U.S. Cl. CPC B60L 53/16; B60L 53/18

(57) ABSTRACT

An electrified vehicle charging assembly includes a charge plug configured to operably coupled to a charge port of an electrified vehicle, a charge cable that connects the charge plug to a power source, and a swivel joint that permits rotation of the charge plug relative to at least a portion of the charge cable.

### TECHNICAL FIELD

This disclosure relates generally to an charging assembly that can be used to charge a traction battery of an electrified vehicle and, more particularly, to a charging assembly having a swivel joint.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Charging assemblies can be used to transfer power from a power source to an electrified vehicle to recharge a traction battery pack of the electrified vehicle. The charging assemblies include a charge plug that is moved into a position where the charge plug is operatively coupled to a charge port.

### SUMMARY

In some aspects, the techniques described herein relate to an electrified vehicle charging assembly, including: a charge plug configured to operably coupled to a charge port of an electrified vehicle; a charge cable that connects the charge plug to a power source; and a swivel joint that permits rotation of the charge plug relative to at least a portion of the charge cable.

In some aspects, the techniques described herein relate to an electrified vehicle charging assembly, wherein the charge plug, charge cable, and the swivel joint configured to transfer power from the power source to at least one traction battery of the electrified vehicle.

In some aspects, the techniques described herein relate to an electrified vehicle charging assembly, wherein the power source is a grid power source.

In some aspects, the techniques described herein relate to an electrified vehicle charging assembly, wherein the charge cable includes a first cable portion extending from the charge plug to the swivel joint, and a second portion extending from the swivel joint to the power source.

In some aspects, the techniques described herein relate to an electrified vehicle charging assembly, wherein the swivel joint connects the charge cable to the charge plug.

In some aspects, the techniques described herein relate to an electrified vehicle charging assembly, wherein the charge cable extends longitudinally along a charge cable axis, the swivel joint permitting rotation of the charge plug relative to at least the portion of the charge cable about the charge cable axis.

In some aspects, the techniques described herein relate to an electrified vehicle charging assembly, wherein the charge cable extends longitudinally along a charge cable axis, the swivel joint permitting rotation of the charge plug relative to at least the portion of the charge cable about an axis that is transverse to the charge cable axis.

In some aspects, the techniques described herein relate to an electrified vehicle charging assembly, wherein the charge cable is a DC fast charge cable.

In some aspects, the techniques described herein relate to an electrified vehicle charging assembly, further including a casing, the swivel joint held within the casing.

In some aspects, the techniques described herein relate to an electrified vehicle charging assembly, wherein the charge cable is a retractable cable.

In some aspects, the techniques described herein relate to an electrified vehicle charging assembly, wherein the swivel joint is configured to convey AC power and DC power.

In some aspects, the techniques described herein relate to an electrified vehicle charging assembly, wherein the swivel joint is a slip ring.

In some aspects, the techniques described herein relate to an electrified vehicle charging assembly, wherein the slip ring is a 500 Amp slip ring.

In some aspects, the techniques described herein relate to an electrified vehicle charging method, including: rotating a charge plug relative to at least a portion of a charge cable through a swivel joint.

In some aspects, the techniques described herein relate to an electrified vehicle charging method, wherein the swivel joint is a slip ring.

In some aspects, the techniques described herein relate to an electrified vehicle charging method, further including operably coupling the charge plug to a charge port of a vehicle, and then charging a traction battery of the vehicle through the charge plug.

In some aspects, the techniques described herein relate to an electrified vehicle charging method, further including connecting together a first portion of the charge cable and a second portion of the charge cable using the swivel joint such that the first portion of the charge cable is infinitely rotatable relative to the second portion of the charge cable.

In some aspects, the techniques described herein relate to an electrified vehicle charging method, further including connecting together the charge plug and the charge cable using the swivel joint such that the charge plug is infinitely rotatable relative to the charge cable.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates a charging assembly positioned to charge an electrified vehicle from a power source according to an exemplary aspect of the present disclosure.

FIG. 2 illustrates a close-up view of the charging assembly of FIG. 1.

FIG. 3 illustrates a close-up view of a charging assembly according to another exemplary aspect of the present disclosure.

FIG. 4 illustrates an example slip ring for use as a swivel joint in the charging assembly of FIG. 2 or the charging assembly of FIG. 3.

FIG. 5 illustrates a close-up view of a portion of the charging assembly of FIG. 2.

FIG. 6 illustrates a portion of a charging assembly according to another exemplary aspect of the present disclosure.

### DETAILED DESCRIPTION

This disclosure relates generally to an electrified vehicle charging assembly including a swivel joint, such as a slip ring. The charging assemblies incorporate a swivel joint that permits rotation of a charge plug. The swivel joint can facilitate manipulating the charger assembly into a position of appropriate for recharging the electrified vehicle.

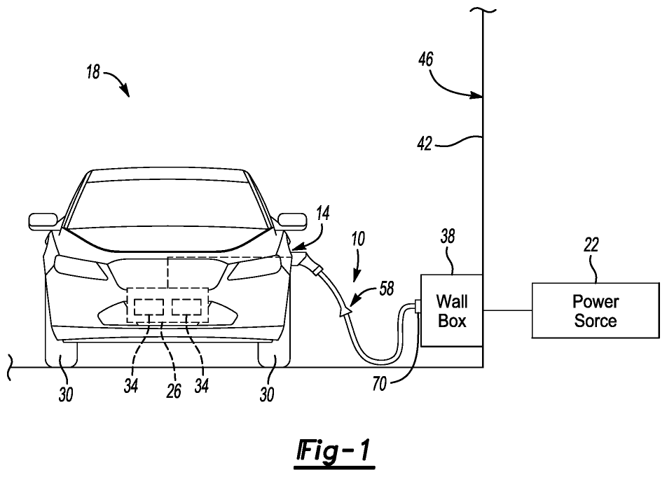

FIG. 1 illustrates an exemplary charging assembly 10 operatively coupled to a charge port 14 of an electrified vehicle 18. The charging assembly 10 is used to transfer energy to the electrified vehicle 18 from a power source 22, which is, in this example, a grid power source. However, in other examples, the power source 22 could be another source of power such as another vehicle, a stand-by battery, a renewable energy source, etc.

The charging assembly 10 can be used at a user's home, a commercial building, a parking garage, a charging station, or another type of structure that is capable of transferring energy to the electrified vehicle 18.

Although a specific component relationship is illustrated in the figures of this disclosure, the illustrations are not intended to limit this disclosure. The placement and orientation of various components of the depicted system are shown schematically and could vary within the scope of this disclosure. In addition, the various figures accompanying this disclosure are not necessarily drawn to scale and some features may be exaggerated or minimized to emphasize certain details of a particular component.

In the exemplary embodiment, the electrified vehicle 18 is a plug-in type electrified vehicle (e.g., a plug-in hybrid electric vehicle PHEV) or a battery electric vehicle (BEV)). The electrified vehicle 18 includes a traction battery pack 26 that is part of an electrified powertrain capable of applying a torque from an electric machine (e.g., an electric motor) for driving drive wheels 30 of the electrified vehicle 18. Therefore, the electrified powertrain of the electrified vehicle 18 can electrically propel the drive wheels 30 either with or without the assistance of an internal combustion engine.

The charging assembly 10 is shown as charging an electrified vehicle 18 that is a car. However, other electrified vehicle configurations re contemplated. The teachings of this disclosure could be applicable for charging assemblies utilized to charge any type of vehicle. For example, the electrified vehicle 18 could be configured as a truck, van, SUV, etc.

The traction battery pack 26 is configured as a high voltage traction battery pack that includes a plurality of battery arrays 34 (i.e., battery assemblies or groupings of individual battery cells) capable of outputting electrical power to one or more electric machines of the electrified vehicle 18. Other types of energy storage devices and/or output devices may be used to electrically power the electrified vehicle 18.

The electrified vehicle 18 interfaces with the power source 22 through the charging assembly 10 to facilitate energy transfer. In an embodiment, the charging assembly 10 is considered electric vehicle supply equipment EVSE. The charging assembly 10 can connect to the power source 22 through a wall box 38 of the EVSE, which can be mounted to a wall 42 of a structure 46, such as a wall of a garage. The charging assembly 10 can then be used to transfer energy to the electrified vehicle 18. In some examples, the charging assembly 10 could be a bi-directional charging assembly capable of transferring energy from the electrified vehicle 18 back through the wall box 38 to the power source 22, or to power loads of the structure 46.

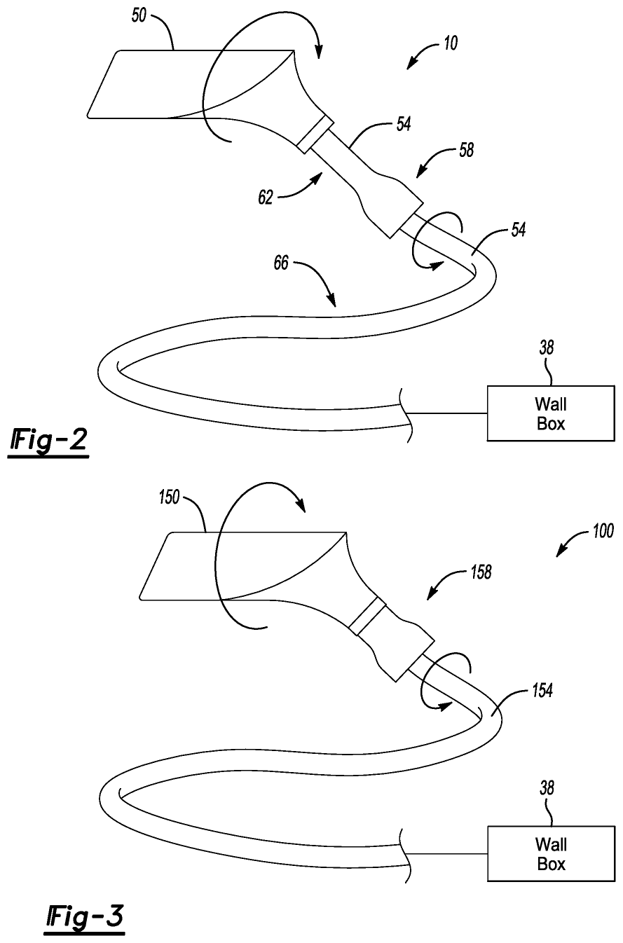

With reference now to FIG. 2, and continued reference to FIG. 1, the charging assembly 10 includes a charge plug 50, a charge cable 54, and a swivel joint 58.

The charge plug 50 is configured to operably couple to the charge port 14 of the electrified vehicle 18. The charge cable 54 connects the charge plug 50 to the power source 22, and in particular the wall box 38 in this example. The wall box 38 can be considered a power source as the wall box 38 is electrically coupled to the power source 22.

The swivel joint 58 permits rotation of the charge plug 50 relative to at least a portion of the charge cable 54. The swivel joint 58 permits, in this example, infinite rotation of the charge plug 50 relative to the portion the charge cable 54.

Typically, a user moves the charge plug 50 from a position where the charge plug 50 is not coupled to the charge port 14 to an engaged position where the charge plug 50 is operably coupled to the charge port 14. This can be considered plugging in the charge plug 50.

As the charge plug 50 is plugged in, rotation of the charge plug 50 relative to at least a portion of the charge cable 54 can facilitate movement and positioning of the charge plug 50 and can help to prevent kinks in the charge cable 54. The swivel joint 58 can facilitate reducing ergonomic challenges as the user operably couples the charge plug 50 to the charge port 14. Maneuverability of the charge plug 50 is thus enhanced by the swivel joint 58.

When the charge plug 50 is operably coupled to the charge port 14, the charging assembly 10 can transfer power from the power source 22 through the swivel joint 58 to the traction battery pack 26 of the electrified vehicle 18.

In the exemplary embodiment of FIG. 2, the swivel joint 58 is positioned such that a first cable portion 62 extends from the charge plug 50 to the swivel joint 58 and a second cable portion 66 then extends from the swivel joint 58 to wall box 38. In a variation shown in a charging assembly 100 shown in FIG. 3, the first cable portion 62 could be eliminated and a swivel joint 158 could be between a charge plug 150 and substantially all of a charge cable 154.

Referring again to FIGS. 1 and 2, the exemplary charging assembly 10 is a charging assembly appropriate for a DC fast charge of the electrified vehicle 18. The charge cable 54, in some examples, can be a retractable cable that winds automatically about a spool 70 when not in use.

The charging assembly 10, in this example, include a casing sleeve 74 that holds the swivel joint 58. The casing sleeve 74 can shield the swivel joint 58 from contaminants.

In an example, as shown in FIG. 4, the swivel joint 58 is a slip ring assembly 78, which is an electric transmission coupling that can transmit power between two electrical parts that are infinitely rotatable relative to each other. The scan transmit power and electrical signals between two rings while permitting relative rotation between the two rings. The slip ring assembly 78 can be a 500 Amp slip ring. The slip ring assembly 78 can be configured to convey both AC power and DC power.

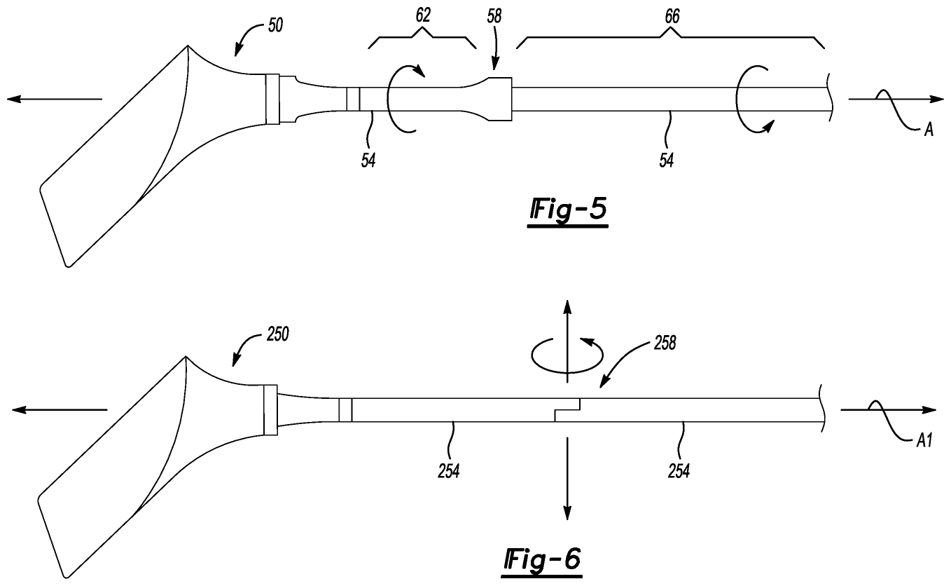

Referring now to FIG. 5 with continuing reference to FIGS. 1 and 2, the charge cable 54, which includes both the first cable portion 62 and the second cable portion 66, extends longitudinally along a charge cable axis A. The swivel joint 58 is configured such that the charge plug 50 together with the first cable portion 62 of the charge cable 54 can rotate about the charge cable axis A relative to the second cable portion 66.

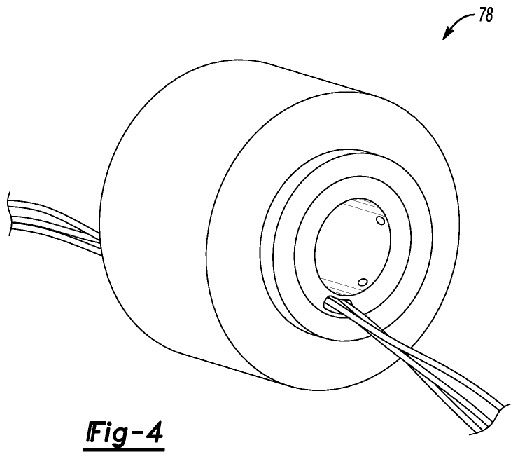

As shown in FIG. 6, in another example, a swivel joint 258 could be configured such that a charge plug 250 can rotate relative to a portion of a chord 254 a rotational axis that is transverse to a charge cable axis A1.

Features of the disclosed examples include a charging assembly having a swivel joint that facilitates positioning of a charge plug to a charge port during a charging procedure. The swivel joint can be particularly useful for charging assemblies having larger diameter and heavier cables.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An electrified vehicle charging assembly, comprising:
a charge plug configured to operably coupled to a charge port of an electrified vehicle;
a charge cable that connects the charge plug to a power source; and
a swivel joint that permits rotation of the charge plug relative to at least a portion of the charge cable.

2. The electrified vehicle charging assembly of claim 1, wherein the charge plug, charge cable, and the swivel joint configured to transfer power from the power source to at least one traction battery of the electrified vehicle.

3. The electrified vehicle charging assembly of claim 1, wherein the power source is a grid power source.

4. The electrified vehicle charging assembly of claim 1, wherein the charge cable includes a first cable portion extending from the charge plug to the swivel joint, and a second portion extending from the swivel joint to the power source.

5. The electrified vehicle charging assembly of claim 1, wherein the swivel joint connects the charge cable to the charge plug.

6. The electrified vehicle charging assembly of claim 1, wherein the charge cable extends longitudinally along a charge cable axis, the swivel joint permitting rotation of the charge plug relative to at least the portion of the charge cable about the charge cable axis.

7. The electrified vehicle charging assembly of claim 1, wherein the charge cable extends longitudinally along a charge cable axis, the swivel joint permitting rotation of the charge plug relative to at least the portion of the charge cable about an axis that is transverse to the charge cable axis.

8. The electrified vehicle charging assembly of claim 1, wherein the charge cable is a DC fast charge cable.

9. The electrified vehicle charging assembly of claim 1, further comprising a casing, the swivel joint held within the casing.

10. The electrified vehicle charging assembly of claim 1, wherein the charge cable is a retractable cable.

11. The electrified vehicle charging assembly of claim 1, wherein the swivel joint is configured to convey AC power and DC power.

12. The electrified vehicle charging assembly of claim 1, wherein the swivel joint is a slip ring.

13. The electrified vehicle charging assembly of claim 12, wherein the slip ring is a 500 Amp slip ring.

14. An electrified vehicle charging method, comprising:
rotating a charge plug relative to at least a portion of a charge cable through a swivel joint.

15. The electrified vehicle charging method of claim 14, wherein the swivel joint is a slip ring.

16. The electrified vehicle charging method of claim 14, further comprising operably coupling the charge plug to a charge port of a vehicle, and then charging a traction battery of the vehicle through the charge plug.

17. The electrified vehicle charging method of claim 14, further comprising connecting together a first portion of the charge cable and a second portion of the charge cable using the swivel joint such that the first portion of the charge cable is infinitely rotatable relative to the second portion of the charge cable.

18. The electrified vehicle charging method of claim 14, further comprising connecting together the charge plug and the charge cable using the swivel joint such that the charge plug is infinitely rotatable relative to the charge cable.
